(19) United States
(12) Patent Application Publication
(10) Pub. No.: US 2020/0116172 A1
(43) Pub. Date: Apr. 16, 2020

(54) FILTER STRUCTURE ON PRESSURE RELIEF VALVE FOR HYDRAULIC TENSIONER

(71) Applicant: BorgWarner Inc., Auburn Hills, MI (US)

(72) Inventor: Young Taek SUN, Gyeonggi-do (KR)

(21) Appl. No.: 16/471,317

(22) PCT Filed: Dec. 21, 2016
(86) PCT No.: PCT/US2016/067910

§ 371 Date: Jun. 19, 2019

(51) Int. Cl. F15B 21/041; F16K 17/04; F16H 7/08

(52) U.S. Cl. CPC F15B 21/041; F16K 17/0406; B01D 46/4272; F16H 2007/0814; F16H 7/08

(57) ABSTRACT

A filter assembled in front of oil inlet hole of a pressure relief valve prevents contamination of the pressure relief valve. A pressure relief valve and filter assembly for a tensioner includes a pressure relief valve comprising a hollow pressure relief valve body defining a chamber, the pressure relief valve body having a first end with an aperture, a second end, and a length extending from the first end to the second end and a filter comprising a filter body and mesh connected to the filter body. The mesh is positioned relative to the aperture such that the mesh prevents contaminants from entering the pressure relief valve through the aperture.

### BACKGROUND OF THE INVENTION

### Field of the Invention

The invention pertains to the field of hydraulic tensioners. More particularly, the invention pertains to a pressure relief valve with a filter.

### Description of Related Art

A pressure relief valve is a reactionary device integral to the hydraulic tensioners of engine timing systems. Pressure relief valves provide a tensioner with two stage leakage, which is a major variable for containing and dissipating energy to maintain proper tension levels without over tensioning a system. When the pressure relief valve is contaminated, the contamination can get stuck between the pressure relief valve body and ball check valve during tensioner use, impeding performance.

### SUMMARY OF THE INVENTION

A filter assembled in front of oil inlet hole of a pressure relief valve prevents contamination of the pressure relief valve.

In one embodiment, a pressure relief valve and filter assembly for a tensioner includes a hollow pressure relief valve body defining a chamber, the pressure relief valve body having a first end with an aperture, a second end, and a length extending from the first end to the second end, a valve member received in the first end of the chamber, a pressure relief stem extending inward from the second end of the chamber and a first biasing member received in the chamber having a second end contacting the pressure relief stem and a first end contacting the valve member. The first biasing member biases the valve member to a position in which the valve member seals the aperture of the pressure relief valve body. The pressure relief valve and filter assembly also includes a filter including a filter body connected to the first end of the pressure relief valve body and mesh connected to the filter body.

In another embodiment, a hydraulic tensioner includes a tensioner body having a bore in fluid communication with a source of pressurized fluid through an inlet, a hollow piston slidably received within the bore, a hydraulic pressure chamber defined by the hollow piston and the bore of the tensioner body, a piston spring received within the hydraulic pressure chamber for biasing the piston away from the inlet, and a pressure relief valve and filter assembly received within the hydraulic pressure chamber. The pressure relief valve and filter assembly includes a hollow pressure relief valve body defining a pressure relief valve chamber, the pressure relief valve body having a first end with an aperture, a second end, and a length extending from the first end to the second end, a valve member received in the first end of the pressure relief valve chamber, a pressure relief stem extending inward from the second end of the pressure relief valve chamber and a valve spring received in the pressure relief valve chamber having a second end contacting the pressure relief stem and a first end contacting the valve member. The valve spring biases the valve member to a position in which the valve member seals the aperture of the pressure relief valve body. The pressure relief valve and filter assembly also includes a filter including a filter body connected to the first end of the pressure relief valve body and mesh connected to the filter body.

In another embodiment, a method of preventing contamination in a pressure relief valve of a hydraulic tensioner includes the step of assembling a filter in front of an aperture of the pressure relief valve.

In another embodiment, a pressure relief valve and filter assembly includes a pressure relief valve comprising a hollow pressure relief valve body defining a chamber, the pressure relief valve body having a first end with an aperture, a second end, and a length extending from the first end to the second end and a filter including a filter body and mesh connected to the filter body, where the mesh is positioned relative to the aperture such that the mesh prevents contaminants from entering the pressure relief valve through the aperture.

### BRIEF DESCRIPTION OF THE DRAWINGS

FIG. 1 shows a tensioner in an embodiment of the present invention.

FIG. 2 shows a perspective view of the tensioner of FIG. 1.

FIG. 3 shows another view of the tensioner of FIG. 1.

FIG. 4 shows another view of the tensioner of FIG. 1.

FIG. 5 shows a cross-sectional view of the tensioner along lines 5-5 of FIG. 1.

FIG. 6 shows a cross-sectional view of the tensioner along lines 6-6 of FIG. 1.

FIG. 7 shows a view of a pressure relief valve and filter assembly in an embodiment of the present invention.

FIG. 8 shows the vent disk end of a pressure relief valve in an embodiment of the present invention.

FIG. 9 shows a cross-sectional view of the pressure relief valve and filter assembly along lines 9-9 of FIG. 8.

FIG. 10 shows a perspective view of the pressure relief valve and filter assembly in an embodiment of the present invention.

FIG. 11 shows a side view of the pressure relief valve and filter assembly in an embodiment of the present invention.

FIG. 12A shows a perspective view of a filter in an embodiment of the present invention.

FIG. 12B shows another perspective view of the filter.

FIG. 13 shows a top view of the filter.

FIG. 14 shows a side view of the filter.

FIG. 15 shows a bottom view of the filter.

FIG. 16 shows a cross-sectional view of the filter along lines 16-16 of FIG. 13.

FIG. 17 shows a close-up view of a portion 17 of the filter shown in FIG. 16.

FIG. 18 shows an image of a mesh filter.

### DETAILED DESCRIPTION OF THE INVENTION

A filter prevents contamination from entering the pressure relief valve. The filter includes mesh and a body and is assembled on the pressure relief valve body. In some preferred embodiments, the mesh is a steel mesh. In other preferred embodiments, the body is made of plastic.

A pressure relief valve controls oil flow by using a ball check valve for opening and closing. Since engines are composed of several materials, including, but not limited to, aluminum, plastic, and steel, any of the components in the engine can contaminate the oil when the engine is running When oil-borne contaminants move into the pressure relief valve, contaminants such as steel can get stuck between the pressure relief valve body and the ball check valve. If this occurs, the ball check valve is unable to close and remains open during the duration of the tensioner operation. When the ball check valve is stuck open, the contaminated pressure relief valve is no longer able to control oil flow in the tensioner. This negatively affects tensioner and chain system performance

The filter preferably includes a body and mesh and is located in front of the oil inlet hole on the pressure relief valve to prevent contaminants from entering the pressure relief valve. The mesh on the filter is made of a material strong enough to endure contaminants including, but not limited to, steel, aluminum and plastic due to high oil pressure fluctuation. In some preferred embodiments, the mesh is made of steel. Other materials that maintain their structure during engine use, for example nylon materials of sufficient strength, could alternatively be used as the material for the mesh. The body of the filter is preferably made of plastic. In some preferred embodiments, the mesh is made of steel and the body of the filter is made of plastic.

Small mesh openings and mesh wire thicknesses are preferable to reduce as much contamination as possible, but the mesh opening size is preferably bigger than the smallest oil passage. In order to make small mesh openings, thin mesh wire is required. However, thin wire has lower strength than thick wire. There is high pressure applied to the inside of a tensioner, so the mesh portion of the filter has to have enough strength to withstand that pressure and maintain its structure during engine use. In one preferred embodiment, the mesh openings are approximately 0.18 mm wide and the mesh wire thickness is approximately 0.14 mm.

In some preferred embodiments, the mesh has a dome shape. In other embodiments, the mesh may lie flat. Since the filter mesh opening size should be bigger than the smallest oil passage, a dome shape is advantageous because it provides more surface area than a flat shape.

The body of the filter is preferably connected to the body of the pressure relief valve. In some preferred embodiments, the body of the filter preferably includes grooves and the pressure relief valve body also includes grooves. The grooves are complementary so that the filter and the pressure relief valve can be assembled together. The filter is assembled on the pressure relief valve directly and the grooves keep the filter from being separated from the pressure relief valve during use.

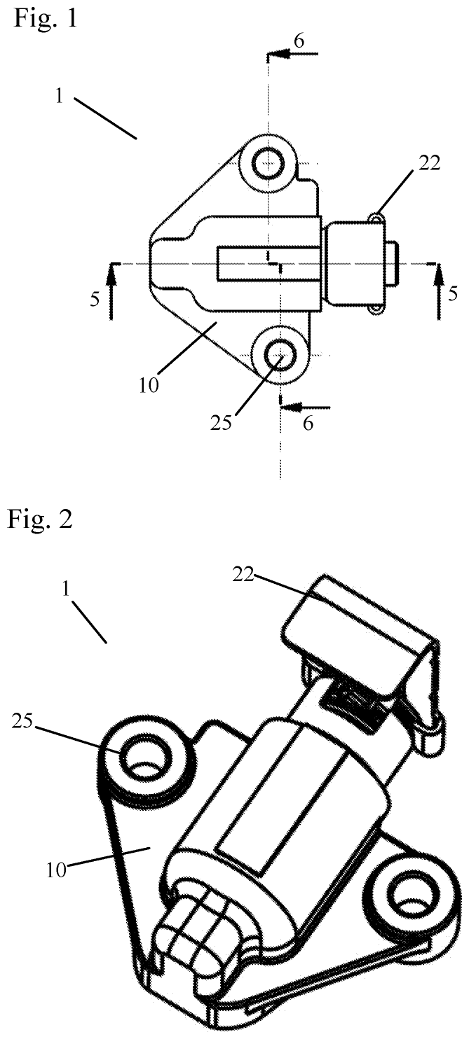

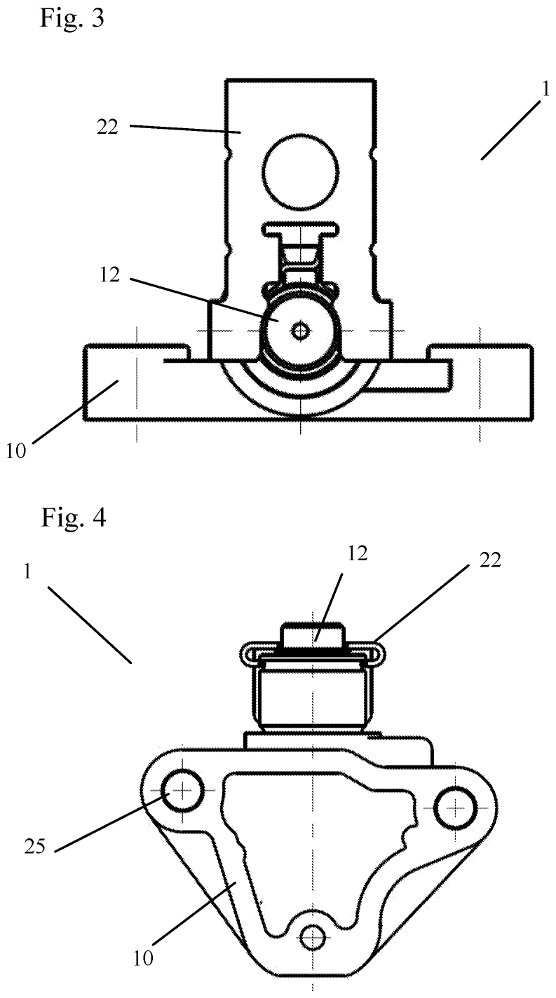

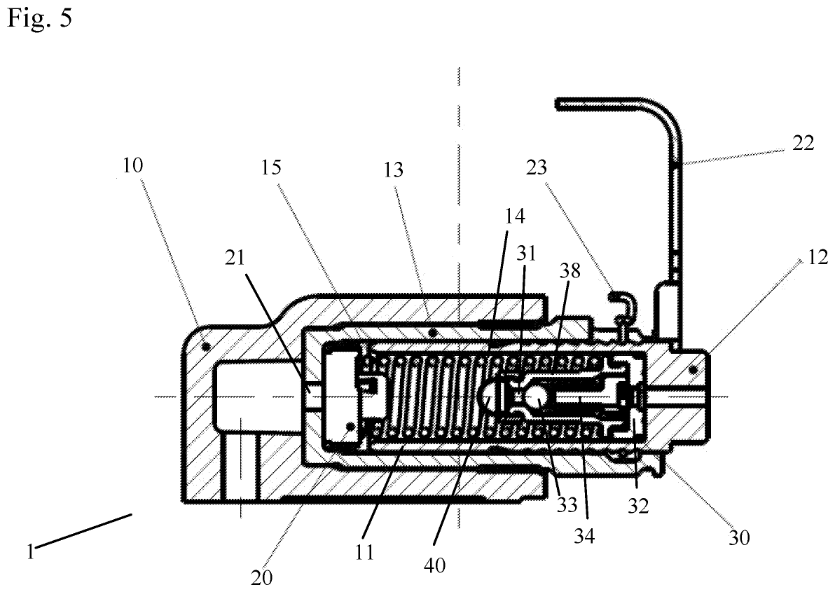

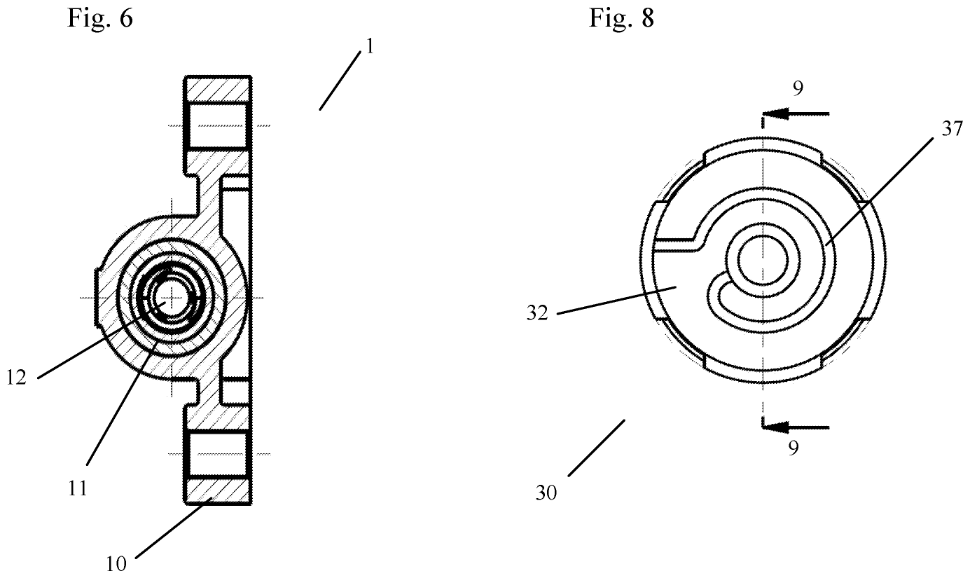

A hydraulic tensioner 1 with a pressure relief valve 30 and filter 40 is shown in FIGS. 1 through 6. The hydraulic tensioner 1 includes a tensioner body 10, a ratchet clip 23, a shipping clip 22, a piston 12, a sleeve or piston housing 13 received within the tensioner body 10, a hydraulic pressure chamber 14, a check valve assembly 20, a pressure relief valve 30, a filter 40 and a spring 15. The tensioner body 10 defines a cylindrical bore 11 for slidably receiving the sleeve 13 with the hollow piston 12. One end of the sleeve 13 contains an inlet 21 in fluid communication with an external supply of pressurized fluid (not shown). The hydraulic pressure chamber 14 is defined by an inner circumference of the hollow piston 12, inner circumference of sleeve 13, compression spring 15 and the check valve and seal assembly 20. The compression spring 15 biases the piston 12 away from the inlet 21. The check valve assembly 20 may be any conventional check valve assembly 20 and is located at the base of the sleeve 13 to allow hydraulic fluid to fill the space in the sleeve 13. The pressure relief valve 30 is located in the opposite end of the piston bore.

Although the tensioner body 10 is shown having at least one mounting hole 25 for mounting the tensioner body 10 to a stationery surface (not shown), the tensioner 1 may alternatively be mounted in a cartridge-style mounting arrangement within the spirit of the invention, where the tensioner 1 is mounted by a thread on the outside of the body 10.

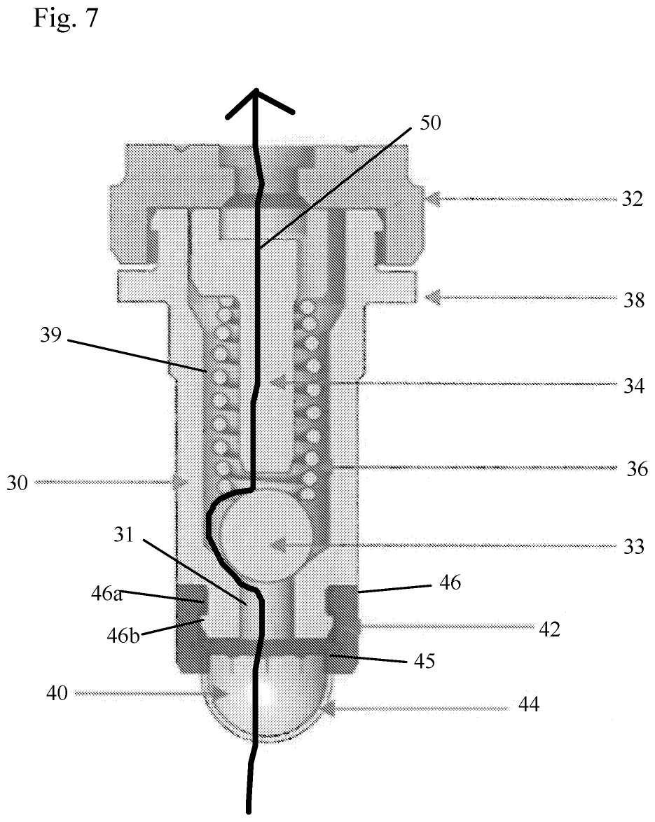

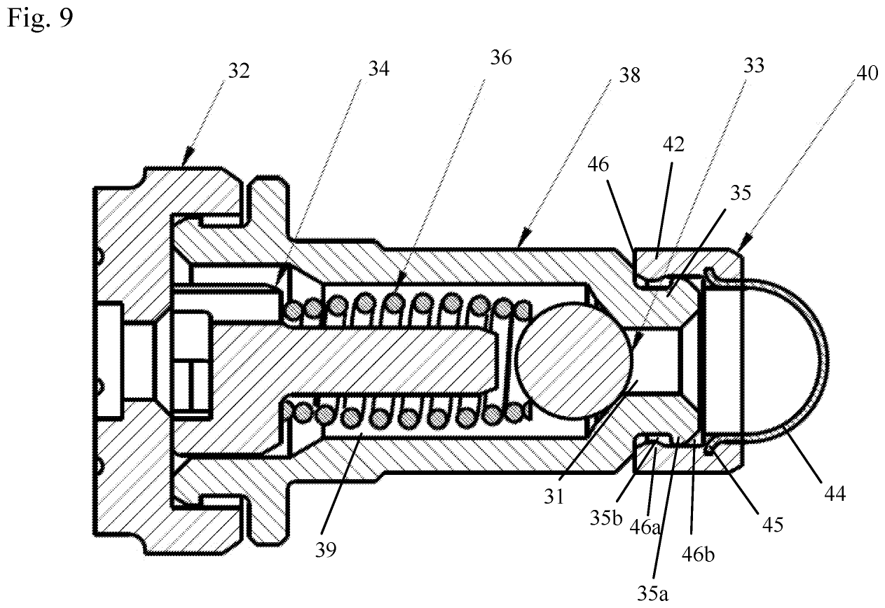

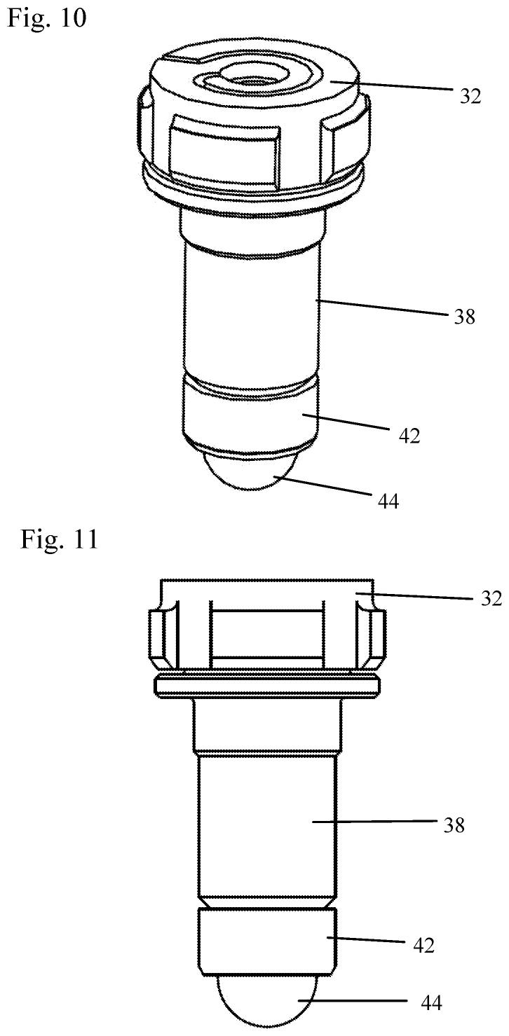

The pressure relief valve 30, shown in FIGS. 7 through 11, includes a hollow pressure relief valve body 38 defining a chamber 39. A pressure relief valve biasing member 36, which is preferably a spring, in the chamber 39 biases a pressure relief valve member 33 to a position in which the valve member 33 seals an oil inlet hole or aperture 31 of the pressure relief valve body 38. While the valve member 33 is shown as a ball valve in the figures, it may have various geometric configurations. For example, the valve member 33 may be a disk or a tapered plug (not shown).

The pressure relief valve 30 also includes a pressure relief valve stem 34 located between the pressure relief valve biasing member 36 and a vent disk or seal 32. The vent seal 32 is preferably a full ring seal or vent 32 with multiple slots which allow fluid flow into a tortuous path 37.

Back flow (e.g. flow away from the hydraulic pressure chamber) travels through the pressure relief valve 30, as shown by arrow 50 in FIG. 7. Pressure relief is provided through the aperture 31, moving the valve member 33 when a certain threshold pressure is reached, relieving pressure through the biasing member 36 towards the pressure relief stem 34 and out the vent 32.

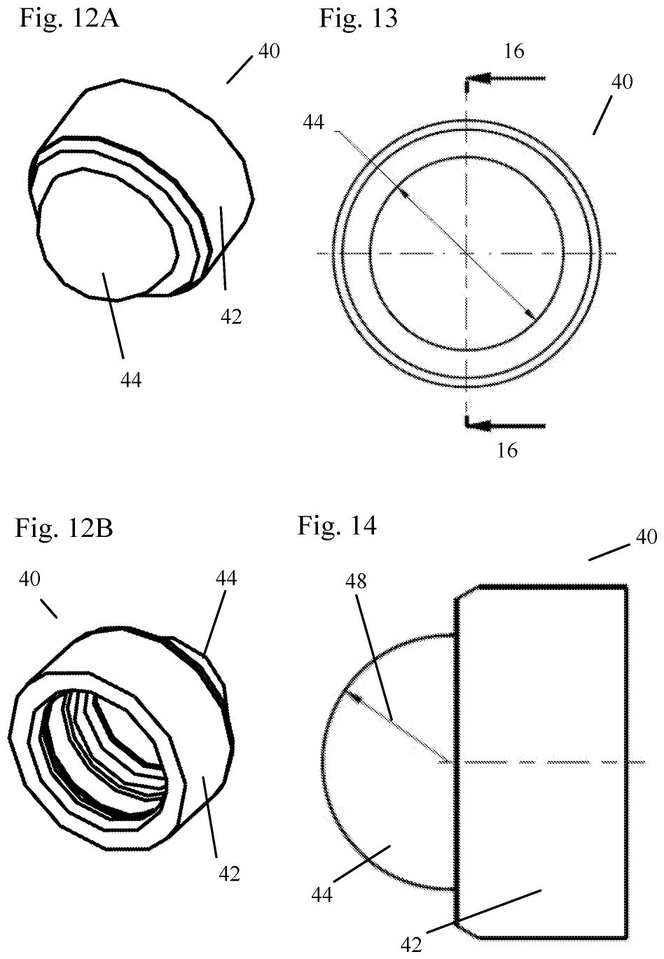

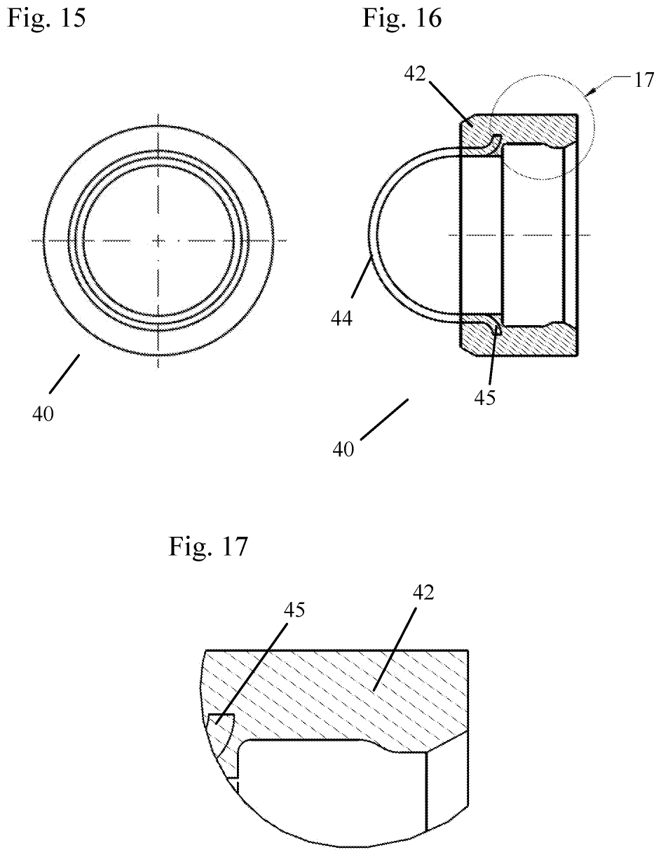

A filter 40 comprising a body 42 and mesh 44, shown in FIGS. 12 through 18, is located in front of the aperture 31 on the pressure relief valve 30. The filter 40 prevents contaminants from entering the pressure relief valve 30 when oil enters the pressure relief valve 30. The ends 45 of the mesh 44 extend into the body 42 of the filter 40. The body 42 of the filter 40 preferably includes an interlocking end 46 that includes a protrusion 46a and a groove 46b that fit into a protrusion 35a and a groove 35b in an interlocking end 35 of the pressure relief valve body 38. More specifically, the protrusion 46a fits into the groove 35b and the protrusion 35a fits into the groove 46b. The protrusions and grooves 35, 46 are complementary to each other so that the filter 40 and the pressure relief valve 30 can be assembled together. The filter 40 is preferably assembled on the pressure relief valve 30 directly and the complementary protrusions and grooves 35, 46 keep the filter 40 from being separated from the pressure relief valve 30 during use.

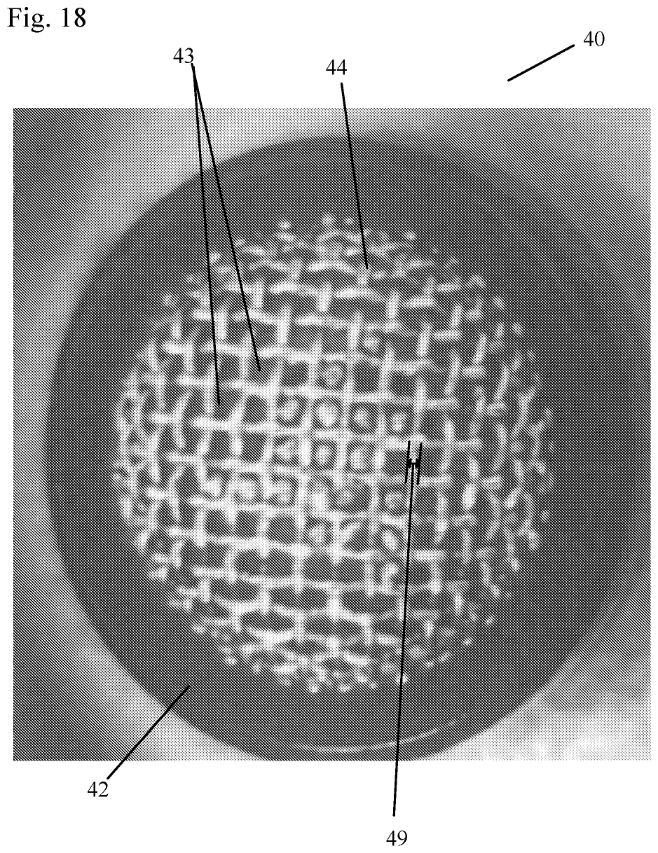

The mesh 44 on the filter 40 is made of a material strong enough to endure contaminants, such as steel, due to high oil pressure fluctuation. In some preferred embodiments, the mesh 44 is made of steel. In one preferred embodiment, the mesh openings 43 are approximately 0.18 mm and the mesh wire thickness 49 is approximately 0.14 mm. Although a weaved mesh 44 is shown in FIG. 18, other mesh types are alternatively possible.

In some preferred embodiments, the filter body 44 is made of plastic. In preferred embodiments, the mesh portion 44 of the filter 42 has a semi-spherical or dome shape. In alternative embodiments, the mesh portion 44 of the filter could lie flat (not shown) across the filter body. In one preferred embodiment, the sphere radius 48 of the mesh is preferably approximately 2.1 mm.

Testing showed that the filter was able to prevent contamination into the pressure relief valve.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A pressure relief valve and filter assembly for a tensioner, comprising:
a hollow pressure relief valve body defining a chamber, the pressure relief valve body having a first end with an aperture, a second end, and a length extending from the first end to the second end,
a valve member received in the first end of the chamber,
a pressure relief stem extending inward from the second end of the chamber;
a first biasing member received in the chamber having a second end contacting the pressure relief stem and a first end contacting the valve member, the first biasing member biasing the valve member to a position in which the valve member seals the aperture of the pressure relief valve body; and
a filter comprising a filter body connected to the first end of the pressure relief valve body and mesh connected to the filter body.

2. The pressure relief valve and filter assembly of claim 1, wherein the pressure relief valve body comprises at least one first protrusion and at least one first groove and the filter body comprises at least one second groove complementary to the first protrusion and at least one second protrusion complementary to the first groove.

3. The pressure relief valve and filter assembly of claim 1, wherein the mesh is semi-spherical.

4. The pressure relief valve and filter assembly of claim 3, wherein the mesh has a radius of approximately 2.1 mm.

5. The pressure relief valve and filter assembly of claim 1, further comprising a vent seal adjacent the second end of the pressure relief valve body defining a plurality of holes to permit backflow of pressurized fluid.

6. The pressure relief valve and filter assembly of claim 1, wherein the mesh is made of steel.

7. The pressure relief valve and filter assembly of claim 1, wherein the filter body is made of plastic.

8. A hydraulic tensioner, comprising:
a tensioner body having a bore in fluid communication with a source of pressurized fluid through an inlet;
a hollow piston slidably received within the bore;
a hydraulic pressure chamber defined by the hollow piston and the bore of the tensioner body;
a piston spring received within the hydraulic pressure chamber for biasing the piston away from the inlet; and
a pressure relief valve and filter assembly received within the hydraulic pressure chamber, comprising:
a hollow pressure relief valve body defining a pressure relief valve chamber, the pressure relief valve body having a first end with an aperture, a second end, and a length extending from the first end to the second end,
a valve member received in the first end of the pressure relief valve chamber,
a pressure relief stem extending inward from the second end of the pressure relief valve chamber;
a valve spring received in the pressure relief valve chamber having a second end contacting the pressure relief stem and a first end contacting the valve member, the valve spring biasing the valve member to a position in which the valve member seals the aperture of the pressure relief valve body; and
a filter comprising a filter body connected to the first end of the pressure relief valve body and mesh connected to the filter body.

9. The tensioner of claim 8, wherein the pressure relief valve body comprises at least one first protrusion and at least one first groove and the filter body comprises at least one second groove complementary to the first protrusion and at least one second protrusion complementary to the first groove.

10. The tensioner of claim 8, wherein the mesh is semi-spherical.

11. The tensioner of claim 8, further comprising a vent seal adjacent the second end of the pressure relief valve body defining a plurality of holes to permit backflow of pressurized fluid.

12. The tensioner of claim 8, wherein the mesh is made of steel.

13. The tensioner of claim 8, wherein the filter body is made of plastic.

14. (canceled)

15. (canceled)

16. A pressure relief valve and filter assembly comprising:
a pressure relief valve comprising a hollow pressure relief valve body defining a chamber, the pressure relief valve body having a first end with an aperture, a second end, and a length extending from the first end to the second end; and
a filter comprising a filter body and mesh connected to the filter body, wherein the mesh is positioned relative to the aperture such that the mesh prevents contaminants from entering the pressure relief valve through the aperture.
